(19) United States
(12) Patent Application Publication
(10) Pub. No.: US 2007/0159937 A1
(43) Pub. Date: Jul. 12, 2007

(54) Method and apparatus for measuring the depth of a data record layer in an information record medium

(75) Inventors: Sjoerd Stallinga, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,894

(22) PCT Filed: Oct. 27, 2004
(86) PCT No.: PCT/IB04/03525

§ 371 Date: May 1, 2006

(30) Foreign Application Priority Data
Nov. 3, 2003 (EP) 03300194.2

(51) Int. Cl. G11B 7/00

(52) U.S. Cl. 369/44.26; 369/44.28

(57) ABSTRACT

Apparatus and method for measuring the depth of data record layers of an optical storage disc having a cover layer of thickness d, an entrance surface (S), and, for example, a first data layer (L0), a second data layer (L1) and a third data layer (L2). The optical apparatus comprises a spherical aberration compensator (SA), and an objective lens (OL) mounted in an actuator (AC), the actuator (AC) receiving a current I and being arranged and configured to move the objective lens (OL) in the z (axial) axis relative to the optical storage disc. Light incident on the objective lens (OL) is converged into a cone-like beam such that it is focussed on one of the data layers (D1). A control signal is used to keep the scanning spot focussed on the data layer (L1). This control signal is the focus error signal (FES) and is provided by the actuator drive (AC). In order to provide the spherical aberration compensator (SA) with right control signal, the depth of each data layer must be measured and means are provided for measuring the depth of the data layer(s) of a single- or multi-layer disc, and this achieved by using the distance between zero-crossings of the focus error signal (FES).

This invention relates to a method and apparatus for measuring the depth of a data record layer in an information record medium, spherical aberration compensating apparatus using such depth measurement, and data recording and/or retrieval apparatus for retrieving data from an information record medium having one or more data record layers including such spherical aberration compensating apparatus.

Optical data storage systems provide a means for storing great quantities of data on a disk. The data is accessed by focussing a laser beam onto the data layer of the disk and then detecting the reflected light beam. In one known system, data is permanently embedded as marks, such as pits, in the disk, and the data is detected as a change in reflectivity as the laser beam passes over the marks.

Erasable optical systems are also known. These systems generally use a laser to heat the data layer above a critical temperature in order to write and erase data. Magneto-optical recording systems record data by orienting the magnetic domain of a spot in either an up or a down position. The data is read by directing a low power laser to the data layer. The differences in magnetic domain direction cause the plane of polarisation of the light beam to be rotated one way or the other, clockwise or anti-clockwise. This change in orientation of polarisation is then detected. Phase change recording uses a structural change of the data layer itself (amorphous and crystalline are two common types of phases) to record the data. Such data is detected as changes in reflectivity as a beam passes over the different phases.

Advances in computer technology call for increased memory capacity. The optical disk, as a two-dimensional optical storage device, is currently the most widespread physical format for optical storage. The data capacity of optical disks can be increased by adding a third physical dimension. This can be done by using a multilayer optical disk, i.e. by axially stacking a number of information carrying layers within a single optical disks. An optical disk having two or more data layers may in theory be accessed at different layers by changing the focal position of a lens.

Several stacked optical disk systems have been proposed, for example, in U.S. Pat. No. 5,202,875 and U.S. Pat. No. 5,255,262, in which a volumetric method for increasing optical disk capacities is disclosed which involves bonding together individual disks in a stack with spacers being provided between adjacent disks to define a gap therebetween. At any one time, a movable lens in the optical disk drive focuses a laser on one surface of one of the disks in order to read data. The focus of the laser is changed repeatedly to sequentially read data from the various disk surfaces. Each disk, or at least all but the disk furthest from the laser source, must be partially transparent so that the laser can be used to read a disk that lies beyond one or more other disks. Each disk surface, however, must also be sufficiently reflective to allow the data to be read.

The optical disc storage technology that employs an optical disc with pit patterns as a high-density, large-capacity recording medium has been put into practical use while expanding its applications to digital versatile discs (DVD), video discs, document file discs and data files. The function required for recording/reproducing information successfully and with high reliability on an optical disc by a finely focussed light beam (e.g. with a diameter of 1 mm or less) are classified into three major categories: a focusing function for forming a diffraction-limited spot, focusing control (focus servo) and tracking control functions of an optical system, and a pit signal (information signal) detecting function.

To improve the recording density of an optical disc further, an increase in the numerical aperture (NA) of an objective lens has been studied recently. The objective lens focuses a light beam on the optical disc to form a diffraction-limited spot. However, spherical aberration, which is caused by an error in thickness of a base material for protecting a data record layer of the optical disc increases strongly with NA. Thus, as optical storage discs increase in density and the NA of the objective lens becomes higher, the influence due to spherical aberration will increase accordingly, such that there will be a distortion in the focus error signal.

In order to solve these problems, mechanisms have been proposed to correct for spherical aberration, such as the provision of a combination lens in an optical pick up, or the provision of a liquid crystal cell in an optical pick-up.

Thus, for a high-NA readout system, as explained above, compensation for spherical aberration is needed, where spherical aberration is the phenomenon whereby the rays in the converging cone of light scanning the disc that are close to the optical axis have a different focal point than the rays in the converging cone that make an angle with the optical axis. This results in blurring of the spot and loss of fidelity in reading out the bit stream. The amount of spherical aberration that needs to be compensated for is proportional to the depth of the data layer it is focussed on, although a fixed amount of spherical aberration is compensated for by the objective lens producing the converging cone of light. This might be sufficient for a disc having only a single layer, but is not sufficient for multi-layer discs. The latter type of discs also need compensation for the variable amount of spherical aberration related to focussing through a variable number of spacer layers.

As stated above, in order to solve these problems, mechanisms have been proposed to correct for spherical aberration, and it will be appreciated by a person skilled in the art that, in order to provide the spherical aberration compensator with a useful control signal, a value for the depth of each data layer must be given, and in the prior art arrangements, the quantity of spherical aberration correction required to be performed by the spherical aberration compensating mechanism is determined based on a standard thickness of layers in a multi-layer disc.

In practice, however, the cover thickness and spacer thickness can vary from disc to disc.

We have now devised an improved arrangement.

Thus, in accordance with the present invention, there is provided apparatus for measuring the depth of a data record layer in an information record medium having one or more data record layers, the apparatus comprising optical element means for focussing a beam of electromagnetic radiation on a data record layer, an actuator for moving said optical element means relative to said information record medium in response to a control current supplied thereto, focus error signal generation means for generating a focus error control signal for controlling said actuator so as to maintain said electromagnetic radiation beam focussed on said data record layer, and means for determining a control current supplied to said actuator at one or more zero-crossings of said focus error signal and determining therefrom the depth of said data record layer in said information record medium.

The optical element may comprise an objective lens, and the apparatus preferably includes means for calculating a proportionality constant between actuator current and depth. The focus error signal may typically comprise a substantially sinusoidal wave, in which case, the proportionality constant may be proportional to a distance between two predetermined points on said wave. These two predetermined points preferably comprise respective positive and negative peaks.

In one embodiment of the invention, the information record medium may be rotating, in which case means are preferably provided to compensate for the resultant oscillation of the information record medium. Such compensating means may comprise means for causing the actuator to substantially follow oscillation of the information record medium, by means of, for example, supplying the actuator with an oscillating current. Alernatively, such compensating means may be arranged to cause the actuator to substantially follow any height variation of the information record medium due to rotation thereof.

The invention further extends to a method of measuring the depth of a data record layer in an information record medium having one or more data record layers, the method comprising providing optical element means for focussing a beam of electromagnetic radiation on a data record layer, providing an actuator for moving said optical element means relative to said information record medium in response to a control current supplied thereto, generating a focus error signal for controlling said actuator so as to maintain said electromagnetic radiation beam focussed on said data record layer, determining a control current supplied to said actuator at one or more zero-crossings of said focus error signal and determining therefrom the depth of said data record layer in said information record medium.

The invention extends further to apparatus for calculating, in respect of an optical system, the depth of a data record layer in an information record medium having one or more data record layers, the optical system comprising optical element means for focussing a beam of electromagnetic radiation on a data record layer, an actuator for moving said optical element means relative to said information record medium in response to a control current supplied thereto, and focus error signal generation means for generating a focus error control signal for controlling said actuator so as to maintain said electromagnetic radiation beam focussed on said data record layer, the apparatus being arranged and configured to determine a control current supplied to said actuator at one or more zero-crossings of said focus error signal and to determine therefrom the depth of said data record layer in said information record medium.

The present invention also provides a method of calculating, in respect of an optical system, the depth of a data record layer in an information record medium having one or more data record layers, the optical system comprising optical element means for focussing a beam of electromagnetic radiation on a data record layer, an actuator for moving said optical element means relative to said information record medium in response to a control current supplied thereto, and focus error signal generation means for generating a focus error control signal for controlling said actuator so as to maintain said electromagnetic radiation beam focussed on said data record layer, the method comprising determining a control current supplied to said actuator at one or more zero-crossings of said focus error signal and determining therefrom the depth of said data record layer in said information record medium.

In one embodiment, the present invention provides spherical aberration compensating apparatus including apparatus as defined above. The present invention may also provide an optical data recording or retrieval system including such spherical aberration compensating apparatus.

Thus, the present invention provides a convenient means to correctly calculate the depth, in an information record medium, of the or each data record layer being read out, thereby overcoming the inaccuracy problems, and resultant deterioration of fidelity, in prior art systems, which is caused by the fact that the thickness and, therefore, depth of such layers may vary from disc to disc.

These and other aspects of the present invention will be apparent from, and elucidated with reference to, the embodiments described herein.

Embodiments of the present invention will now be described by way of examples only and with reference to the accompanying drawings, in which:

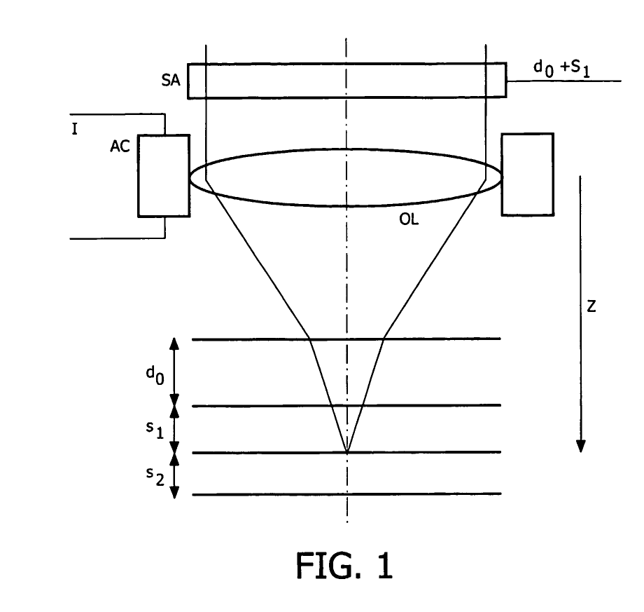

FIG. 1 is a schematic partial illustration of apparatus according to a first exemplary embodiment of the present invention;

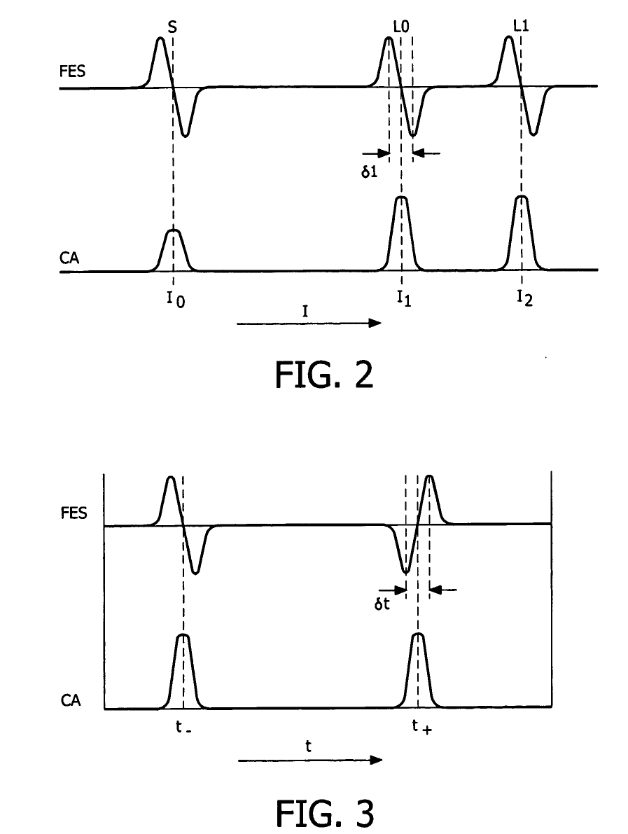

FIG. 2 illustrates schematically the focus error signal (FES) and central aperture (CA) signal as a function of actuator current I, generated in respect of a first exemplary embodiment of the present invention;

FIG. 3 illustrates schematically the focus error signal (FES) and central aperture (CA) signal as a function of time t, generated in respect of a second exemplary embodiment of the present invention;

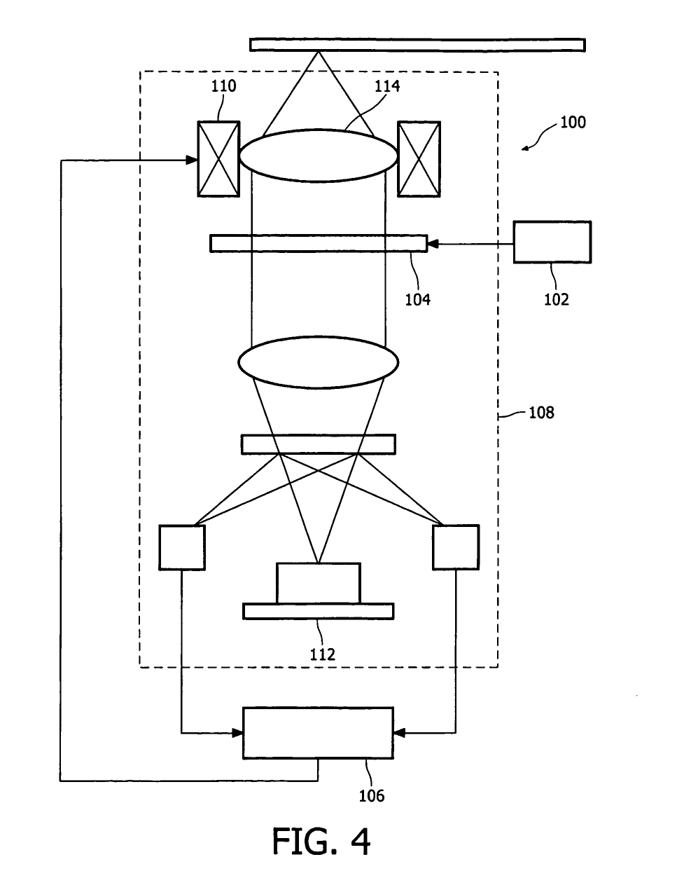

FIG. 4 illustrates schematically a typical optical system; and

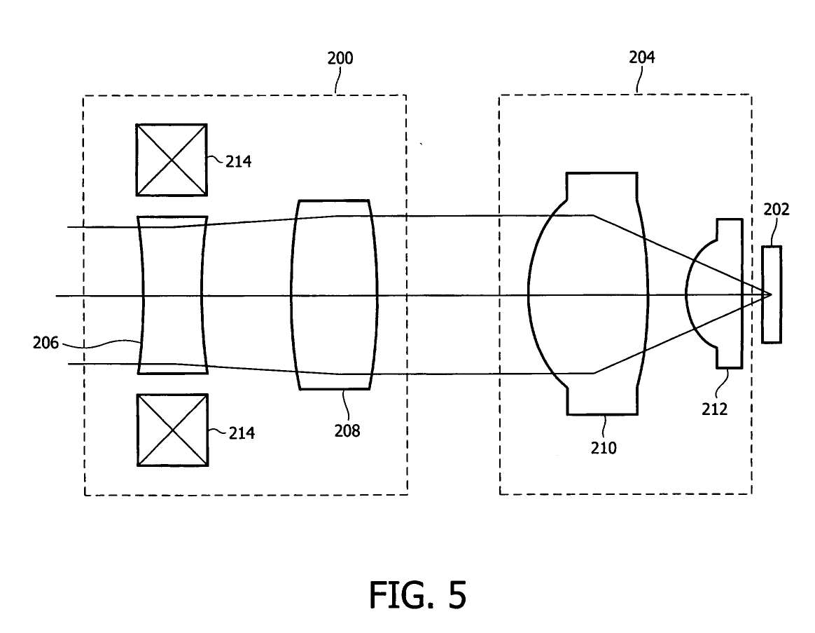

FIG. 5 illustrates schematically elements of a typical spherical aberration compensating mechanism.

FIG. 4 shows a known optical disk apparatus 100, comprising an aberration correcting element driving circuit 102 that applies a voltage to an aberration correcting element, such as a liquid crystal aberration correcting element, 104, and a control circuit 106 that receives a signal from the optical pickup 108 and controls and drives an actuator 110, the aberration correcting element driving circuit 102, and a laser source 112. The control circuit 106 causes the laser source 112 to emit a light beam and controls the position an objective lens 114 based on the signal from the optical pickup 108. Moreover, it drives the aberration correcting element driving circuit 102 to improve information signals from the optical pickup 108.

FIG. 5 illustrates the components of an optical system other than a laser source, a collimator lens, and a photodetector. A light beam that has been converted into parallel light by a collimator lens passes through an aberration correcting lens group 200 and is focussed on an optical disc 202 by an objective lens group 204. The aberration correcting lens group 200 includes a negative lens group 206 and a positive lens group 208. The objective lens group 204 includes an objective lens 210 and a forward lens 212. The space between the negative and positive lens groups 206, 208 is changed to correct spherical aberration in the entire optical system. To change the space between the two lens groups, a driving portion 214 that shifts the negative lens group 206 in the optical axis direction can, for example, be used. The driving portion 214 may be formed by, for example, a voice coil, a piezoelectric element, an ultrasonic motor, a screw feeder, or the like.

Although a specific example is described above, many different types of known spherical aberration correcting means are known, and the present invention is not intended to be limited in this regard.

Referring to FIG. 1 of the drawings, consider an optical storage disc having a cover layer of thickness d and having an entrance surface S, a first data layer L0, a second data layer L1 and a third data layer L2. The optical apparatus comprises a spherical aberration compensator SA, and an objective lens OL mounted in an actuator AC, the actuator AC receiving a current I and being arranged and configured to move the objective lens OL in the z (axial) axis relative to the optical storage disc.

In the illustrated example, light incident on the objective lens OL is converged into a cone-like beam such that it is focussed on the second data layer L1, in this case (although it may be any one of the data layers). A control signal is used to keep the scanning spot focussed on the data layer L1. This control signal is the focus error signal (FES) and is provided by the actuator drive. The FES equals zero when the scanning spot is in focus. When the control circuit (not shown) is switched on, the FES is kept to zero by varying the current that drives the actuator AC.

It will be appreciated from FIG. 1 that data layer L0 is at depth d₀ in the optical storage disc, data layer L1 is at a depth d₁=d₀+s₁, and data layer L2 is at depth d₂=d₀+s₁+s₂, where d₀, s₁, s₂ can vary from disc to disc. In order to provide the spherical aberration compensator SA with right control signal, the depth of each data layer must be measured and the present invention is intended to provide means for measuring the depth of the data layer(s) of a single- or multi-layer disc. The coordinate z measures the distance between the objective lens OL and the data layer being read out, and the spherical aberration compensator SA is controlled by the depth (d=d₀+s₁, in this case) of the data layer.

Referring to FIG. 2 of the drawings, there is shown the focus error signal (FES) and a central aperture (CA) signal (which is the sum signal of all the light collected at the different segments of the detector) as a function of the actuator current. In general, the difference in the actuator current for the zero-crossings of the focus error signal is a measure for the axial distance between corresponding data layers, as will now be explained in more detail.

In the first embodiment, the disc is not rotating and a scan of the actuator current I is made, resulting in the signals illustrated in FIG. 2. A measure of length is the length of the focus S-curve b, i.e. the z-distance between the positive and negative peak of the focus error signal FES. This length b is a known design parameter and can, therefore be used to translate currents into distances. The proportionality constant k between current and distance is then:
k=b/dI

The cover and spacer thickness values then follow as:
d₀=k(I₁−I₀)
s₁=k(I₂−I₁)
s₂=k(I₃−I₂)

In a second embodiment of the present invention, the disc is rotating, such that the actual height z is not constant (as in the first embodiment), but instead it varies with time:
z(t)=z_{c}+Dz cos(vt+j)
where v is the angular frequency of the disc rotation and f is a phase offset. This oscillation arises because the rotation axis is never perfectly perpendicular to the disc surface. In this embodiment, typically, the focus error signal FES and the central aperture (CA) signal will look as illustrated in FIG. 3 of the drawings. The above-described effect of disc rotation can be substantially eliminated by oscillating the actuator AC so that it follows the oscillation due to the disc rotation, and this can be achieved by adding a small oscillating current through the actuator AC:
I(t)=DI cos(vt+f′)
then adjusting the phase f′ such that the times where the zero-crossings occur (t_{- and t}₊ respectively in FIG. 3) do not vary with respect to the situation without the additional oscillating current through the actuator (then we have f=f′), and then finally adjusting the current amplitude DI such that the variation of the signals FES and CA with time are eliminated. After these preparatory steps, the method described above with reference to FIG. 2 can be applied to measure the various thickness values.

In a third embodiment, the disc is once again rotating, but a different procedure may be used to cancel the effects of the disc rotation. In this case, the focus control circuit may be used to make the actuator AC follow the height variation due to the disc rotation. The current I(t) during one disc revolution is recorded, after which the focus control circuit is switched off again. A current Iₛ+I(t) is fed into the actuator and the FES and CA signals are measured as a function of Iₛ, such that the various thickness values can be measured in accordance with the method described with reference to FIG. 2 of the drawings. Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. Apparatus for measuring the depth of a data record layer in an information record medium having one or more data record layers, the apparatus comprising optical element means for focusing a beam of electromagnetic radiation on a data record layer, an actuator for moving said optical element means relative to said information record medium in response to a control current supplied thereto, focus error signal generation means for generating a focus error control signal for controlling said actuator so as to maintain said electromagnetic radiation beam focused on said data record layer, and means for determining a control current supplied to said actuator at one or more zero-crossings of said focus error signal and determining therefrom the depth of said data record layer in said information record medium.

2. Apparatus according to claim 1, wherein the optical element comprises an objective lens.

3. Apparatus according to claim 1, further including means for calculating a proportionality constant between actuator current and depth.

4. Apparatus according to claim 3, wherein the focus error signal comprises a substantially sinusoidal wave, and the proportionality constant is proportional to a distance between two predetermined points on said wave.

5. Apparatus according to claim 4, wherein said two predetermined points comprise respective positive and negative peaks.

6. Apparatus according to claim 1 wherein the information record medium is rotating, and the apparatus further comprises means arranged and configured to compensate for the resultant oscillation of the information record medium.

7. Apparatus according to claim 6, wherein said compensating means comprises means for causing the actuator to substantially follow oscillation of the information record medium.

8. Apparatus according to claim 7, comprising means for supplying the actuator with an oscillating current.

9. Apparatus according to claim 6, wherein said compensating means is arranged to cause the actuator to substantially follow any height variation of the information record medium due to rotation thereof.

10. A method of measuring the depth of a data record layer in an information record medium having one or more data record layers, the method comprising providing optical element means for focusing a beam of electromagnetic radiation on a data record layer, providing an actuator for moving said optical element means relative to said information record medium in response to a control current supplied thereto, generating a focus error signal for controlling said actuator so as to maintain said electromagnetic radiation beam focused on said data record layer, determining a control current supplied to said actuator at one or more zero-crossings of said focus error signal and determining therefrom the depth of said data record layer in said information record medium.

11. Apparatus for calculating, in respect of an optical system, the depth of a data record layer in an information record medium having one or more data record layers, the optical system comprising optical element means for focusing a beam of electromagnetic radiation on a data record layer, an actuator for moving said optical element means relative to said information record medium in response to a control current supplied thereto, and focus error signal generation means for generating a focus error control signal for controlling said actuator so as to maintain said electromagnetic radiation beam focused on said data record layer, the apparatus being arranged and configured to determine a control current supplied to said actuator at one or more zero-crossings of said focus error signal and to determine therefrom the depth of said data record layer in said information record medium.

12. A method of calculating, in respect of an optical system, the depth of a data record layer in an information record medium having one or more data record layers, the optical system comprising optical element means for focusing a beam of electromagnetic radiation on a data record layer, an actuator for moving said optical element means relative to said information record medium in response to a control current supplied thereto, and focus error signal generation means for generating a focus error control signal for controlling said actuator so as to maintain said electromagnetic radiation beam focused on said data record layer, the method comprising determining a control current supplied to said actuator at one or more zero-crossings of said focus error signal and determining therefrom the depth of said data record layer in said information record medium.

13. Spherical aberration compensating apparatus including apparatus according to claim 1.

14. An optical data recording or retrieval system including spherical aberration compensating apparatus according to claim 13.
